(19) United States
(12) Patent Application Publication
(10) Pub. No.: US 2022/0063108 A1
(43) Pub. Date: Mar. 3, 2022

(54) DEVICE, SYSTEM AND METHOD FOR ASSISTING MOBILE ROBOT OPERATIONS

(71) Applicant: STARSHIP TECHNOLOGIES OÜ, Tallinn (EE)

(72) Inventor: Siim VIILUP, Tallinn (EE)

(21) Appl. No.: 17/423,190

(22) PCT Filed: Jan. 28, 2020
(86) PCT No.: PCT/EP2020/052052

§ 371 Date: Jul. 15, 2021

(30) Foreign Application Priority Data
Jan. 28, 2019 (EP) 19154006.1

(51) Int. Cl. B25J 11/00; B25J 9/16; B25J 15/00; B25J 13/08; G05B 19/4155

(52) U.S. Cl. CPC B25J 11/008; B25J 9/162; G05B 2219/50391; B25J 13/08; G05B 19/4155; B25J 15/0019

(57) ABSTRACT

Disclosed are a device, system and method for assisting mobile robots. A service robot is disclosed comprising a body; a motion component fitted to the body and configured to propel the service robot in a direction; an engagement component configured to exert a localized force on a geometrically defined interaction area; a sensor configured to detect the interaction area; and a communication component configured to at least communicate with mobile robots and to at least receive requests to engage the interaction area. A system comprising a mobile robot and a service robot is also disclosed. A method comprising a mobile robot approaching a pedestrian road crossing at a first location; the mobile robot requesting assistance from a service robot; the service robot executing at least one assistive action; and in response to the assistive action, the mobile robot crossing the road via the pedestrian road crossing is also disclosed.

### FIELD

The invention relates to mobile robots. More specifically, the invention relates to service robots assisting mobile robots in their operations.

### INTRODUCTION

Recently, robots have been used for more and more tasks. Mobile robots are frequently used both in indoor and outdoor settings. Such robots can provide goods or services, such as deliver items, provide security or interact with humans. Mobile robots are often built for a specific task or set of tasks, any may not be as versatile in their motor skills as humans. Such robots navigating unstructured indoor or outdoor surroundings may encounter barriers that would be difficult to traverse. For example, pushbuttons meant for humans (such as elevator or road crossing ones) may present a challenge for a mobile robot.

This problem has been addressed in some prior art. For example, U.S. Pat. No. 8,010,230 B2 describes systems, methods and devices for the automated retrieval/delivery of goods from one location to another using a robotic device such as a tug and accompanying cart. The patent describes possible interaction between the robotic device and an elevator as follows. In preferred embodiments, the tug uses an elevator of a hospital using onboard electronics that allow the tug to “take over” the control of the elevator by communicating directly with the building's elevator systems. The tug can call the elevator and select a destination floor using a wireless signal.

A software-based interaction between a mobile robot and a system such as an elevator may not always be possible or preferred. For example, the relevant authorities or controllers may not be willing to provide a software-level integration between arbitrary mobile robots and systems under their control (e.g. elevators, pedestrian crossing pushbuttons, door-opening pushbuttons, etc.). Therefore, it can be advantageous to provide a hardware or mechanical way of interaction between mobile robots and systems optimized for human use (e.g. pushbuttons of all kinds).

For example, “Autonomous pedestrian push button activation by outdoor mobile robot in outdoor environments” published in Journal of Robotics and Mechatronics 25 (3):484-496 June 2013 by Aneesh N. Chand, Shinichi Yuta describes a mobile robot capable of traversing traffic roads via pedestrian crossings by activating the pedestrian pushbutton with a mechanical finger.

### SUMMARY

It is the object of the present invention to provide an improved and reliable way of assisting mobile robots with their operations. It is further the object to optimize, streamline and facilitate mobile robot operations. It is also the object to provide ways for mobile robots to interact with systems optimized for human use. It is also the object to provide a service robot that is configured to interact with mobile robots in order to assist with their operations.

In a first embodiment, a service robot configured to assist mobile robots is disclosed. The service robot comprises a body and a motion component fitted to the body and configured to propel the service robot in a direction. The service robot further comprises an engagement component configured to exert a localized force on a geometrically defined interaction area. The service robot also comprises a sensor configured to detect the interaction area. The service robot further comprises a communication component configured to at least communicate with mobile robots and to at least receive requests to engage the interaction area.

The present service robot is particularly advantageous for assisting mobile robot operations. The mobile robot may have a certain task or goal. For example, the mobile robot may be an item delivery robot, a vending robot, a service providing robot or the like. In order to execute its task or goal, the mobile robot may need to access areas that may require human-like interaction. For example, engaging a pedestrian traffic light, calling an elevator, opening a door or similar actions may require an interaction amounting to pushing a button. The mobile robot may not have or otherwise need a capability to perform such interactions (such as pushing buttons), and therefore would not be able to access areas such as pedestrian road crossings, elevators, or button-activated doors. The service robot can advantageously assist or help the mobile robot with performing such interactions, so that the mobile robot can then access these areas. The service robot may serve a plurality of mobile robot in different locations, and itself be mobile and navigate between different locations where it may be needed.

The motion component of the service robot may comprise, for example, wheels, so that the service robot can be propelled along a surface in a certain direction.

The term localized force as used herein may refer to a force applied to a certain specific area. In other words, the engagement component is such that a force can be applied selectively to a button. That is, the engagement component may have a relatively narrow end, so that force can be applied selectively to an area with a diameter smaller than 10 cm, such as 5 cm, preferably smaller than 3 cm.

The term geometrically defined interaction area may refer to an area separated from its surroundings in some way. For instance, a button such as a pushbutton would constitute such a geometrically defined interaction area.

The communication component of the service robot may comprise a modem and, additionally, a short-range communication component, such as one optimized for the Bluetooth protocol for example.

In some embodiments, the interaction area can comprise a pushbutton. That is, the service robot can be advantageously configured to engage pushbuttons by applying a force to them (that is, pushing them).

In some such embodiments, the interaction area can comprise a pedestrian crossing pushbutton. Advantageously, the service robot can then push such a pushbutton, thereby ensuring that a traffic light switches to a pedestrian crossing light. In this way, the service robot can ensure that a mobile robot travelling on sidewalks and similar pedestrian pathways can cross a traffic road safely and according to regulations. This can be particularly useful for traffic lights that only change to a pedestrian crossing light after a pushbutton is pushed.

In some embodiments, the interaction area can comprise a door opening pushbutton. That is, upon engaging of such a pushbutton, a door of a building, room, container, fence, or a similar structure may be opened. In this way, the service robot can advantageously ensure that a mobile robot can enter a certain area that may have been inaccessible to it otherwise.

In some embodiments, the interaction area can comprise an elevator pushbutton. That is, the service robot can advantageously “call” an elevator for the mobile robot. The service robot can then ride the elevator with the mobile robot so as to ensure that a correct floor is reached, and that the mobile robot can ride the elevator back.

In some embodiments, the engagement component can be motor operated. That is, the engagement component can be actuated via a motor. The trajectory of such actuation may be linear or, preferably, curved.

In some embodiments, the engagement component can comprise a mechanical arm. The arm may be a telescoping arm. The mechanical arm can advantageously allow for precise engagement of an interaction area such as a pushbutton.

In some embodiments, the engagement component can be configured to exert a force of at least 10 N, preferably at least 20 N on the interaction area. That is, the engagement component can exert enough force to push a pushbutton that is meant for human interaction.

In some embodiments, the engagement component can be further configured to exert a force of at most 200 N, preferably at most 100 N on the interaction area. This can be advantageous, as the service robot is generally meant for operation in environments suitable for humans and for engaging various pushbuttons or the like. Therefore, the service robot should preferably not be capable of exerting excessive force such as, for example, industrial robots may be. Such excessive force may break or damage pushbuttons configured for human use.

In some embodiments, the sensor can be fitted to the engagement component. In other words, the sensor can be located at the end, or close to the end of the engagement component, so that the interaction area can be more precisely detected by the sensor.

In some embodiments, the sensor can comprise a camera. The camera may be a visual camera, an IR camera or the like. The sensor can also comprise a plurality of sensors. That is, there may be a camera and an ultrasonic sensor, or a camera and a Time of Flight sensor that can combine their readings for better localization of the interaction area.

In some embodiments, the engagement component can comprise at least two positions. That is, the engagement component can assume different positions via actuation. The positions can comprise an idle position and an active position. In the idle position, the engagement component can be substantially flush with an upper surface of the body. That is, the engagement component may be “folded” or “tucked away” close to the body of the service robot, so that it does not impede its movement or otherwise get in the way. The upper surface of the body can be substantially concave. The engagement component can then be substantially concave as well, to fit flush with the body of the service robot. In the active position, the engagement component can be substantially protruding from the body. The engagement component can be protruding from the body by at least 10 cm, preferably by at least 20 cm. In this way, the engagement component can access an interaction area in the vicinity of the service robot, but not immediately adjacent to it. It should be understood that “protruding from” generally refers in this context to an end of the engagement component that is not firmly attached to the body of the service robot located at such a distance from the service robot's body. In other words, the protruding may be horizontal, vertical, or a combination of both. It can be generally understood as a distance between a far end of the engagement component (the one not firmly attached to the body of the service robot) and a closest point on the body of the service robot to it. Put simply, the engagement component can generally protrude from the service robot's body substantially horizontally or substantially vertically, or in a combination of both. Such different positions of the engagement component would then correspond to different heights than an end of the engagement component would reach, and therefore be able to engage interaction areas located at different heights.

The service robot can further comprise a plurality of active positions. Each active position can correspond to the engagement component at a different height with respect to the body. In other words, as mentioned above, the engagement component can engage interaction areas located at varied heights by assuming a plurality of different active positions. The height with respect to the body can generally be measured as a vertical distance between a far end of the engagement component (the end that is not firmly attached to the mobile robot) and a height of the robot body (either average height or the highest point of the body). Alternating between different active positions may be performed via at least partially rotational motion.

The engagement component can be configured to actuate from the idle position to the active position in response to a request to engage the interaction area. The request may come from a mobile robot, or from an external source such as a server coordinating mobile robot operations.

In some embodiments, the engagement component can be configured to actuate from the idle position to one of the active positions. The precise active position to actuate to may be chosen based on the sensor detecting the interaction area. In other words, depending on the detected position of the interaction area, the service robot may select a particular active position to actuate to. Such a position may be defined by the vertical position of the interaction area. The service robot may select such a position autonomously and/or be instructed by an outside server and/or a remote operator.

In some embodiments, the motion component can be configured to adjust the service robot's position in response to the sensor detecting the interaction area. That is, the motion component can move the service robot (for example, by actuating the wheels forming the motion component), so that it is better aligned with the interaction area, and can engage it easier via the engagement component.

In some embodiments, the motion component can be configured to displace the body substantially vertically in response to the sensor detecting the interaction area. That is, the motion component can provide not only horizontal motion, but some amount of vertical motion as well. For example, with the wheels serving as a motion component, there may be a further wheel mechanism that allows to raise the service robot's body by selectively pushing on some of the wheels (for instance, a middle pair of wheels may be raised by pushing on a back pair of wheels). This can provide additional maneuverability to the service robot, so that the interaction area may be quicker and easier accessed. In some such embodiments, the substantially vertical displacement can comprise at least 3 cm, preferably at least 5 cm.

In some embodiments, the engagement component can be configured to exert a localized force on an area at a height of between 80 and 150 cm above ground, preferably at a height of between 90 and 130 cm above ground. This height is generally where pushbuttons designed for humans are placed. In this way, the service robot may be able to access such typical pushbuttons and thereby grant access to the mobile robot to areas which otherwise might be unavailable.

In some embodiments, the service robot can further comprise a processing component configured to control the service robot's operation. Such control may comprise controlling the motion component (such as moving in a direction), the engagement component (such as changing from an idle position to an active one) and the communication component (such as sending or receiving and processing instructions, sensor data, operational data or the like). The processing component can generally serve to operate the service robot.

In some embodiments, the sensor of the service robot can comprise at least one of a camera, a stereo camera, a radar sensor, an ultrasonic sensor, a time of flight sensor, and a lidar sensor. The service robot may comprise a plurality of sensors of the same and/or different type. The sensors may additionally be used to sense the robot's surroundings, for example, to detect any cars present on a traffic road intersection, and/or to detect state of a pedestrian traffic light.

In the present disclosure, two types of robots are presented. Mobile robots as used herein refer to robots configured to travel in outdoor and indoor surroundings and perform various tasks such as item delivery or transportation. Service robot as used herein refers to a robot (or robots) that may generally resemble the mobile robots, but that is tasked with assisting their operations, such as assisting with road crossing or building navigation.

In a second embodiment, a system for assisting mobile robots is disclosed. The system comprises at least one mobile robot configured to navigate in unstructured outdoor environments on pedestrian walkways. The system further comprises at least one service robot according to any of the preceding device embodiments. The service robot is configured to assist the mobile robot by engaging the interaction area.

The environment where the mobile robot travels can typically be an unstructured outdoor environment that changes with time and the geographical surroundings of the robots as it travels along its path. The environment can also be at least partially indoor, or under a roof, for example if the robot is travelling through a mall, garage, apartment complex, office buildings, or the like. This unstructured environment can comprise at least one or any combination of pedestrian paths comprising stationary and moving obstacles (for example pedestrians, animals, strollers, wheelchairs, mailboxes, trash cans, street lights and the like), vehicle roads including vehicles, bicycles, traffic lights and the like and/or other traversable environments such as parking lots, lawns and/or fields.

In some embodiments, the service robot can be configured to assist the mobile robot upon request from the mobile robot. For example, the mobile robot may send a request for assistance upon arriving to a pedestrian road crossing, or while on the way.

In some embodiments, the service robot can be configured to assist the mobile robot at a predetermined time. That is, the mobile robot might have a set schedule, so that it arrives to a location where the service robot may assist it, at a certain time.

In some embodiments, the mobile robot can be an item delivery robot. That is, the mobile robot may travel and navigate indoors and outdoors in order to deliver packages, meals, groceries, mail, newspapers or other goods.

In some embodiments, the service robot can be configured to assist the mobile robot at a first location and time upon request. That is, the assistance may be performed at a specified first location at a first time. For example, the first location may comprise a pedestrian road crossing, or a button-accessible building.

In some embodiments, the service robot can be configured to assist the mobile robot by pressing a pedestrian crossing pushbutton so as to enable the mobile robot to cross a traffic road. Advantageously, this can allow the mobile robot to proceed with its task or towards its destination via an optimal route (that includes a road crossing).

In some embodiments, the system can further comprise a server configured to communicate with the mobile robot and the service robot. The server may coordinate operations of a service robot and a mobile robot. More preferably, the server may coordinate a plurality of mobile robots and one or more service robots operating within a certain region, such as a neighborhood. The server may be a remote server, such as a cloud server. It may also comprise a plurality of servers. There may be an operator supervising the operations of the mobile robot and/or the service.

In some such embodiments, the server can be configured to instruct the service robot to navigate to the first location where the service robot can assist the mobile robot. That is, the server may compute an estimated time of arrival for the mobile robot, and instruct the service robot to start navigation so as to arrive before the mobile robot or at about the same time. Operations can then be optimized.

In some preferred embodiments, the system can comprise a plurality of mobile robots. That is, multiple mobile robots may be roaming in a certain area, each with an own task (these can be similar tasks, such as grocery delivery and/or different tasks, such as providing vending services and delivering mail).

In some such embodiments, the server can be configured to optimize the service robot placement based on ongoing mobile robot operations. Advantageously, this can allow to organize the entire network of mobile robots and one or more service robots in such a way that optimized the efficiency. In other words, the time that the mobile robots need to perform their tasks (such as item delivery) can then be optimized by ensuring that the service robot is present in a location where its assistance may be needed (such as a road crossing). The service robot can move between different locations where it may assist different mobile robots in different ways (e.g. push a pedestrian pushbutton for one mobile robot, call an elevator for another, push a fence button to let a third one enter an area etc.). Such an overall optimization can be implemented via a routing algorithm taking into consideration a plurality of tasks assigned to a plurality of mobile robots (each task with a corresponding location and proposed route). The service robot's route can then be generated based on the estimated time of arrival of various mobile robots to various locations where the service robot's assistance may be needed.

In some such embodiments, the server can be configured to instruct the service robot to arrive at the first location and time so as to assist a mobile robot arriving at the first location and time. That is, the arrival times of the service robot and the mobile robot can be coordinated.

In some such embodiments, the server can be configured to estimate navigational time of the service robot and the mobile robot and instruct the service robot to start navigating to the first location.

In some embodiments, the interaction area can comprise a pushbutton and the service robot can be configured to push it. That is, the assistance that the service robot can provide to the mobile robot can be a result of pushing a pushbutton.

In a third embodiment, a system for assisting mobile robots is disclosed. The system comprises at least one mobile robot configured to navigate in unstructured outdoor environments on pedestrian walkways and comprising a robot communication component. The system also comprises at least one service robot comprising a body and a motion component fitted to the body and configured to propel the service robot in a direction. Wherein the service robot also comprises at least one sensor configured to measure sensor data. And the service robot further comprises a communication component configured for two-way communication with the mobile robot's communication component. Wherein the service robot is configured to assist the mobile robot.

The service robot can then assist the mobile robot by transmitting the sensor data.

In some such embodiments, the service robot can be configured to assist the mobile robot with traffic road crossing.

In some such embodiments, the service robot can be configured to send sensor data to the mobile robot upon request, said sensor data reflecting traffic road conditions.

In some such embodiments, the sensor data can be reflective of a traffic road region falling outside the mobile robot's field of view. That is, the service robot may be placed in such a way, that it can see areas that the mobile robot does not see (either due to the geometry of the road and/or to possible occlusions). The service robot may then send additional data to the mobile robot, which can for example show whether a car is approaching from, a direction that the mobile robot cannot see due to its position.

In some such embodiments, the sensor of the service robot can comprise at least one of a camera, a stereo camera, a radar sensor, an ultrasonic sensor, a time of flight sensor, and a lidar sensor. The service robot may comprise a plurality of sensors of the same and/or different type.

For example, the service robot may comprise a plurality of cameras, one or more time of flight sensors and one or more radars. The combination of such sensors can be advantageously used to determine conditions related to the service robot's surroundings. Such surroundings may comprise e.g. road crossings such as pedestrian road crossings. The sensors can then be used for multiple purposes: detecting vehicles on the traffic road, identifying the state of the pedestrian traffic light, detecting pedestrians at or around the road crossing, or the like. The service robot can then transmit the detected information about its surroundings to one or more mobile robots travelling in the vicinity. If the robots are preparing to cross the road at the road crossing, they may use the service robot's data to perform the crossing more safely. This can be particularly useful when the service robot has more and/or better sensors than the mobile robot or when it is positioned differently to the mobile robot, so that the field of view of its sensors differs from that of the mobile robot, and it may see in its blind spots, occluded zones and/or areas too far away (e.g. the traffic light across the road).

In some embodiments, the service robot can be configured to communicate with a plurality of mobile robots and to coordinate their crossing of a traffic road. In other words, the service robot may serve as a “hub” or “controller” of road crossing activities of many mobile robots. The coordination may include instructing a particular robot to cross and others to wait, instructing the robots to cross in tandem (e.g. in pairs or in a column formation), deciding the order in which the robots should cross (and/or receiving such instructions/decisions from a server, and relaying them to the robots). This can be useful, as in a busy crossing, a plurality of robots can approach it simultaneously or within a short interval and crowd the sidewalks around the crossing. The service robot may then also instruct the robots to wait for their turn to cross a certain distance away from the crossing. The time needed for a plurality of robots to cross the road can be significantly decreased by using the service robot, as the robots may not need to stop right before crossing the road and use their sensors to confirm that the crossing is safe, but may instead rely on the service robot's command to do so.

In some such embodiments, the service robot can be configured to guide a plurality of mobile robots across an intersection of a traffic road in a predetermined formation. The formation may depend on the crossing in question, e.g. larger crossings may allow for a formation of “pairs of robots” crossing side by side, followed by next pairs of robots. Furthermore, the presence and number of pedestrians, cyclists and other traffic participants that may be using the pedestrian crossing at any given time may also influence the crossing formation. Even further, the crossing formation may be adjusted or changed during the crossing if any conditions of the crossing change. Advantageously, adapting the crossing formation to the current situation or parameters associated with the crossing may allow to further streamline the time needed for many robots to cross a road and to overall optimize mobile robot operations.

In some embodiments, the service robot can be configured to simultaneously optimise a plurality of mobile robots crossing a traffic road intersection. As also discussed above, coordinating in which order/formation and at which point mobile robots should perform the crossing may advantageously allow to reduce overall time, energy and resource use of the mobile robots and streamline their operations.

The optimisation can be based at least in part on order of arrival of the mobile robots at the intersection. That is, robots that arrive at the intersection first, may be allowed to cross it first as well. The optimization can also be based at least in part on urgency of operations of mobile robots. For example, some robots may be performing a more pressing task than others (e.g. a robot delivering a hot meal as compared to a robot delivering a package). Such robots may be allowed to cross the road first or before robots performing less urgent tasks. The optimization can also be based at least in part on items carried by mobile robots. For instance, robots carrying more valuable items may be allowed to cross first, so that they may arrive to their destinations faster. The optimization can also be based at least in part on next destination of mobile robots. For example, robots travelling to a further destination may be allowed to cross first or vice versa. Additionally or alternatively, robots travelling to a destination prioritized higher than other destinations may be allowed to cross first as well.

In some embodiments, the system can further comprise a plurality of mobile robots, each configured to navigate in unstructured outdoor environments on pedestrian walkways and each comprising a robot communication component. In other words, the system may comprise a network of mobile robots travelling within a certain area and assisted by a service robot, particularly in connection with crossing the road.

In some embodiments, the system can further comprise a server configured to communicate with the service robot and the mobile robots. The server may perform most or all of the computations related to routing the mobile robots and optimizing a plurality of mobile robots crossing the road. The server may transfer the instructions to the robots directly and/or via the service robot. Additionally or alternatively, some computations relating to authorizing mobile robots to cross the road may be performed on the server, and some on the service robot.

In some such embodiments, the server can be configured to instruct the service robot to navigate to a specific location. That is, the server may coordinate and monitor operation of mobile robots in a certain region or area, and determine that the service robot would be needed at a certain location of this area (e.g. a particularly busy road crossing).

In some such embodiments, the server can be further configured to analyze historic and/or real-time data to determine an optimal location to send the service robot. For example, if a certain intersection historically gets busy during rush hour (e.g. 15:00-19:00), the service robot may be instructed to arrive there shortly before traffic may increase (and mobile robot crossing become more complex) and/or if an increase in traffic is detected.

In some such embodiments, the server can be configured to coordinate travel paths of the mobile robots and the service robot so as to optimise overall operations of mobile robots within a predetermined area. That is, the server can advantageously reduce overall time, energy and other resources that are needed to operate mobile robots within the area, under certain constraints (e.g. certain tasks or delivery runs of mobile robots may be prioritized).

In some embodiments, the service robot can be configured to assist the mobile robot by detecting a state of the traffic light and transmitting it to the mobile robot. This can be particularly useful, as the service robot may be stationed at a location from which the traffic light is easily visible via a camera or a similar sensor, which may not be the case for the robot that needs to cross the road.

In a fourth embodiment, a method for assisting mobile robots is disclosed. The method comprises a mobile robot approaching a pedestrian road crossing at a first location. The method further comprises the mobile robot requesting assistance from a service robot. The method also comprises the service robot executing at least one assistive action. The method further comprises the mobile robot crossing the road via the pedestrian road crossing in response to the assistive action.

In some such embodiments, the assistive action can comprise engaging a pedestrian crossing pushbutton.

In some embodiments, the method can further comprise the service robot travelling to the first location ahead of the mobile robot so as to provide assistive action upon arrival of the mobile robot. That is, the service robot may arrive to the first location before the mobile robot, so as to optimize the mobile robot operating time.

In some embodiments, the method can further comprise the service robot departing the first location after executing the assistive action.

In some such embodiments, the method can further comprise the service robot travelling to a second location and providing an assistive action to a second mobile robot at the second location. That is, advantageously, the service robot can move between different locations where its assistance may be needed.

In some embodiments, the assistive action can comprise sending the mobile robot sensor data. In some such embodiments, the method can further comprise the service robot sensing data indicative of road crossing conditions and transmitting this data to the mobile robot. This data can comprise, for example, vehicles travelling in the road but not visible in the mobile robot's sensors' field of view, data relating to the state of the traffic light (e.g. whether the pedestrian crossing light is green or not), data indicative of any pedestrians or other traffic participants that may be using the pedestrian crossing are present or not.

In some such embodiments, the service robot can use at least one sensor to sense the data, and the sensor can comprise at least one of a camera, a stereo camera, a radar sensor, an ultrasonic sensor, a time of flight sensor and a lidar sensor. A plurality of sensors and/or a combination of sensors can also be used. The time of flight sensor can be particularly advantageous in low light conditions (where cameras may distinguish less details) and/or in tandem with cameras or other sensors.

In some embodiments, the method can further comprise a plurality of mobile robots approaching the pedestrian road crossing within a predetermined time interval and the service robot coordinating road crossing for the plurality of mobile robots.

In some such embodiments, the method can further comprise the service robot determining crossing order of the mobile robots based on predetermined parameters.

In some embodiments, the assistive action can comprise the service robot detecting traffic light state and transmitting it to the mobile robot.

The service robot and the mobile robot of the method can be as described in the above embodiments.

In a fifth embodiment, a method for assisting mobile robots is disclosed. The method comprises monitoring mobile robot operations in a predetermined region. The method also comprises estimating a first location and time when assistance will be required by at least one mobile robot. The method further comprises instructing a service robot to navigate to the first location at the estimated time. The method also comprises the service robot executing an assistive action for the at least one mobile robot upon arrival.

In some such embodiments, the assistive action can comprise the service robot engaging a pedestrian crossing pushbutton. Additionally or alternatively, the assistive action can also comprise the service robot sending the mobile robot sensor data that the mobile robot would otherwise have no access to. For example, this data can comprise visual or radar data from a part of the road that the mobile robot has no access to.

In some embodiments, the assistive action can comprise sending the mobile robot sensor data. The service robot can sense data indicative of road crossing conditions and transmitting this data to the mobile robot. This can be particularly useful when the service robot has the intersection or crossing within the field of view of its sensors, but from a different perspective than the mobile robot. In other words, the service robot can measure data that would be in the mobile robot's blind spots or occluded/obscured otherwise.

In some embodiments, the service robot can use at least one sensor to sense the data, and the sensor can comprise at least one of a camera, a stereo camera, a radar sensor, an ultrasonic sensor, a time of flight sensor, and a lidar sensor. A combination of sensors can be used as well.

In some embodiments, the method can further comprise the service robot executing at least one assistive action for a plurality of mobile robots at the first location. That is, the service robot can, for example, send a plurality of robots data that facilitates them crossing the road, coordinate such crossing and/or instruct the mobile robots to cross when it deems it safe to do so.

In some embodiments, the method can further comprise the mobile robot crossing a traffic road following receiving the assistive action. That is, the assistive action provided by the service robot may enable the mobile robot to safely and securely perform the road crossing.

In some embodiments, the assistive action can comprise observing state of a traffic light and transmitting it to the mobile robot. This can be particularly advantageous in the case of large traffic roads where the traffic lights may be placed on the other side of the crossing, where they might be difficult to spot and interpret for the mobile robot. In such cases, the service robot can be placed in such a way so as to easily observe the state of the traffic lights and indicate to the mobile robot whether the pedestrian light is on (and i.e. whether the mobile robot is then authorized to cross the road).

In some embodiments, the method can also comprise the service robot departing the first location upon providing the assistive action.

In some such embodiments, the method can further comprise the service robot travelling to a second location and providing an assistive action to at least one second mobile robot at the second location.

The mobile robot can be an autonomous or a semi-autonomous robot configured for ground-based travel. Note, that as used herein, the terms autonomous or semi-autonomous robot can be used to mean any level of automation depending on the task that the robot is performing. That is, the robot can be adapted to function autonomously or semi-autonomously for most of the tasks, but can also be remotely controlled for some other tasks.

Then, the robot would be non-autonomous during the time it is controlled, and then autonomous and/or semi-autonomous again when it is no longer controlled. For example, the robot can assume any of the levels of automation as defined by the Society of Automotive Engineers (SAE), that is, the levels as given below.
Level 0—No Automation
Level 1—Driver Assistance
Level 2—Partial Automation
Level 3—Conditional Automation
Level 4—High Automation
Level 5—Full Automation

Though the levels usually refer to vehicles such as cars, they can also be used in the context of the mobile robot. That is, Level 0 can correspond to a remote terminal fully controlling the robot. Levels 1-4 can correspond to the remote terminal partially controlling the robot, that is, monitoring the robot, stopping the robot or otherwise assisting the robot with the motion. Level 5 can correspond to the robot driving autonomously without being controlled by a remote terminal such as a server or a remote operator (in this case, the robot can still be in communication with the remote terminal and receive instructions at regular intervals).

The present invention is also defined by the following numbered embodiments.

Below is a list of device embodiments. Those will be indicated with a letter “D”. Whenever such embodiments are referred to, this will be done by referring to “D” embodiments.

D1. A service robot configured to assist mobile robots, the service robot comprising
A body;
A motion component fitted to the body and configured to propel the service robot in a direction;
An engagement component configured to exert a localized force on a geometrically defined interaction area;
A sensor configured to detect the interaction area;
A communication component configured to at least communicate with mobile robots and to at least receive requests to engage the interaction area.

D2. The service robot according to the preceding embodiment wherein the interaction area comprises a pushbutton.

D3. The service robot according to the preceding embodiment wherein the interaction area comprises a pedestrian crossing pushbutton.

D4. The service robot according to embodiment D2 wherein the interaction area comprises a door opening pushbutton.

D5. The service robot according to embodiment D2 wherein the interaction area comprises an elevator pushbutton.

D6. The service robot according to any of the preceding embodiments wherein the engagement component is motor operated.

D7. The service robot according to any of the preceding embodiments wherein the engagement component comprises a mechanical arm.

D8. The service robot according to any of the preceding embodiments wherein the engagement component is configured to exert a force of at least 10 N, preferably at least 20 N on the interaction area.

D9. The service robot according to any of the preceding embodiments wherein the engagement component is configured to exert a force of at most 200N, preferably at most 100 N on the interaction area.

D10. The service robot according to any of the preceding embodiments wherein the sensor is fitted to the engagement component.

D11. The service robot according to any of the preceding embodiments wherein the sensor comprises a camera.

D12. The service robot according to any of the preceding embodiments wherein the engagement component comprises at least two positions.

D13. The service robot according to the preceding embodiment wherein the positions comprise an idle position and an active position.

D14. The service robot according to the preceding embodiment wherein in the idle position the engagement component is substantially flush with an upper surface of the body.

D15. The service robot according to the preceding embodiment wherein the upper surface is substantially concave.

D16. The service robot according to any of the preceding embodiments and with the features of embodiment D13 wherein in the active position the engagement component is substantially protruding from the body.

D17. The service robot according to the preceding embodiment wherein the engagement component is protruding from the body by at least 10 cm, preferably at least 20 cm.

D18. The service robot according to any of the preceding embodiments and with the features of embodiment D13 further comprising a plurality of active positions wherein each active position corresponds to the engagement component at a different height with respect to the body.

D19. The service robot according to any of the preceding embodiments and with the features of embodiment D13 wherein the engagement component is configured to actuate from the idle position to the active position in response to a request to engage the interaction area.

D20. The service robot according to any of the preceding embodiments and with the features of embodiment D18 wherein the engagement component is configured to actuate from the idle position to one of the active positions and wherein the active position to actuate to is chosen based on the sensor detecting the interaction area.

D21. The service robot according to any of the preceding embodiments wherein the motion component is configured to adjust the service robot's position in response to the sensor detecting the interaction area.

D22. The service robot according to any of the preceding embodiments wherein the motion component is configured to displace the body substantially vertically in response to the sensor detecting the interaction area

D23. The service robot according to the preceding embodiment wherein the displacement comprises at least 3 cm, preferably at least 5 cm.

D24. The service robot according to any of the preceding embodiments wherein the engagement component is configured to exert a localized force on an area at a height of between 80 and 150 cm above ground, preferably at a height of between 90 and 130 cm above ground.

D25. The service robot according to any of the preceding embodiments further comprising a processing component configured to control the service robot's operation including controlling the motion component, the engagement component and the communication component.

D26. The service robot according to any of the preceding embodiments wherein the sensor comprises at least one of
A camera;
A stereo camera;
A radar sensor;
An ultrasonic sensor;
A time of flight sensor; and
A lidar sensor.

Below is a list of system embodiments. Those will be indicated with a letter “S”. Whenever such embodiments are referred to, this will be done by referring to “S” embodiments.

S1. A system for assisting mobile robots, the system comprising
At least one mobile robot configured to navigate in unstructured outdoor environments on pedestrian walkways;
At least one service robot according to any of the preceding device embodiments;

Wherein the service robot is configured to assist the mobile robot by engaging the interaction area.

S2. The system according to the preceding embodiment wherein the service robot is configured to assist the mobile robot upon request from the mobile robot.

S3. The system according to any of the preceding system embodiments wherein the service robot is configured to assist the mobile robot at a predetermined time.

S4. The system according to any of the preceding system embodiments wherein the mobile robot is an item delivery robot.

S5. The system according to any of the preceding system embodiments wherein the service robot is configured to assist the mobile robot at a first location and time upon request.

S6. The system according to any of the preceding system embodiments wherein the service robot is configured to assist the mobile robot by pressing a pedestrian crossing pushbutton so as to enable the mobile robot to cross a traffic road.

S7. The system according to any of the preceding system embodiments wherein the system further comprises a server configured to communicate with the mobile robot and the service robot.

S8. The system according to the preceding embodiment and with the features of embodiment S5 wherein the server is configured to instruct the service robot to navigate to the first location where the service robot can assist the mobile robot.

S9. The system according to any of the preceding system embodiments wherein the system comprises a plurality of mobile robots.

S10. The system according to any of the preceding system embodiments and with the features of embodiment S7 wherein the server is configured to optimize the service robot placement based on ongoing mobile robot operations.

S11. The system according to the preceding embodiment wherein the server is configured to instruct the service robot to arrive at the first location and time so as to assist a mobile robot arriving at the first location and time.

S12. The system according to any of the two preceding system embodiments wherein the server is configured to estimate navigational time of the service robot and the mobile robot and instruct the service robot to start navigating to the first location.

S13. The system according to any of the preceding system embodiments wherein the interaction area comprises a pushbutton and the service robot is configured to push it.

S14. A system for assisting mobile robots, the system comprising
At least one mobile robot configured to navigate in unstructured outdoor environments on pedestrian walkways and comprising a robot communication component;
At least one service robot comprising
   A body;
   A motion component fitted to the body and configured to propel the service robot in a direction;
   At least one sensor configured to measure sensor data
   A communication component configured for two-way communication with the mobile robot's communication component
Wherein the service robot is configured to assist the mobile robot.

S15. The system according to the preceding embodiment wherein the service robot is configured to assist the mobile robot with traffic road crossing.

S16. The system according to any of the two preceding embodiments wherein the service robot is configured to send sensor data to the mobile robot upon request, said sensor data reflecting traffic road conditions.

S17. The system according to the preceding embodiment wherein the sensor data is reflective of a traffic road region falling outside the mobile robot's field of view.

S18. The system according to any of the preceding embodiments S14 to S17 wherein the sensor comprises at least one of
A camera;
A stereo camera;
A radar sensor;
An ultrasonic sensor;
A time of flight sensor; and
A lidar sensor.

S19. The system according to any of the preceding embodiments S14 to S18 wherein the service robot is configured to communicate with a plurality of mobile robots and to coordinate their crossing of a traffic road.

S20. The system according to the preceding embodiment wherein the service robot is configured to guide a plurality of mobile robots across an intersection of a traffic road in a predetermined formation.

S21. The system according to any of the two preceding embodiments wherein the service robot is configured to simultaneously optimise a plurality of mobile robots crossing a traffic road intersection.

S22. The system according to the preceding embodiment wherein the optimisation is based at least in part on
Order of arrival of the mobile robots at the intersection;
Urgency of operations of mobile robots;
Items carried by mobile robots; and
Next destination of mobile robots.

S23. The system according to any of the preceding embodiments S14 to S21 further comprising a plurality of mobile robots each configured to navigate in unstructured outdoor environments on pedestrian walkways and each comprising a robot communication component.

S24. The system according to the preceding embodiment further comprising a server configured to communicate with the service robot and the mobile robots.

S25. The system according to the preceding embodiment wherein the server is configured to instruct the service robot to navigate to a specific location.

S26. The system according to the preceding embodiment wherein the server is further configured to analyse historic and/or real-time data to determine an optimal location to send the service robot.

S27. The system according to any of the three preceding embodiments wherein the server is configured to coordinate travel paths of the mobile robots and the service robot so as to optimise overall operations of mobile robots within a predetermined area.

S28. The system according to any of the preceding embodiments S14 to S28 wherein the service robot is configured to assist the mobile robot by detecting a state of the traffic light and transmitting it to the mobile robot.

Below is a list of method embodiments. Those will be indicated with a letter “M”. Whenever such embodiments are referred to, this will be done by referring to “M” embodiments.

M1. A method for assisting mobile robots, the method comprising
A mobile robot approaching a pedestrian road crossing at a first location;
The mobile robot requesting assistance from a service robot;
The service robot executing at least one assistive action;
In response to the assistive action, the mobile robot crossing the road via the pedestrian road crossing.

M2. The method according to the preceding embodiment wherein the assistive action comprises engaging a pedestrian crossing pushbutton.

M3. The method according to any of the preceding method embodiments further comprising the service robot travelling to the first location ahead of the mobile robot so as to provide assistive action upon arrival of the mobile robot.

M4. The method according to any of the preceding method embodiments further comprising the service robot departing the first location after executing the assistive action.

M5. The method according to the preceding embodiment further comprising the service robot travelling to a second location and providing an assistive action to a second mobile robot at the second location.

M6. The method according to any of the preceding method embodiments wherein the service robot is as described in any of the device embodiments.

M7. The method according to any of the preceding method embodiments wherein the assistive action comprises sending the mobile robot sensor data.

M8. The method according to the preceding embodiment further comprising the service robot sensing data indicative of road crossing conditions and transmitting this data to the mobile robot.

M9. The method according to the preceding embodiment wherein the service robot uses at least one sensor to sense the data, and wherein the sensor comprises at least one of
A camera;
A stereo camera;
A radar sensor;
An ultrasonic sensor;
A time of flight sensor; and
A lidar sensor.

M10. The method according to any of the preceding method embodiments further comprising a plurality of mobile robots approaching the pedestrian road crossing within a predetermined time interval and the service robot coordinating road crossing for the plurality of mobile robots.

M11. The method according to the preceding embodiment further comprising the service robot determining crossing order of the mobile robots based on predetermined parameters.

M12. The method according to any of the preceding method embodiments wherein the assistive action comprises the service robot detecting traffic light state and transmitting it to the mobile robot.

M13. A method for assisting mobile robots, the method comprising
Monitoring mobile robot operations in a predetermined region;
Estimating a first location and time when assistance will be required by at least one mobile robot;
Instructing a service robot to navigate to the first location at the estimated time;
Upon arrival, the service robot executing an assistive action for the at least one mobile robot.

M14. The method according to the preceding embodiment wherein the assistive action comprises the service robot engaging a pedestrian crossing pushbutton.

M15. The method according to any of the two preceding embodiments wherein the assistive action comprises sending the mobile robot sensor data.

M16. The method according to the preceding embodiment further comprising the service robot sensing data indicative of road crossing conditions and transmitting this data to the mobile robot.

M17. The method according to the preceding embodiment wherein the service robot uses at least one sensor to sense the data, and wherein the sensor comprises at least one of
A camera;
A stereo camera;
A radar sensor;
An ultrasonic sensor;
A time of flight sensor; and
A lidar sensor.

M18. The method according to any of the five preceding embodiments further comprising instructing the service robot departing the first location upon providing the assistive action.

M19. The method according to the preceding embodiment further comprising the service robot travelling to a second location and providing an assistive action to at least one second mobile robot at the second location.

M20. The method according to any of the seven preceding embodiments further comprising the service robot executing at least one assistive action for a plurality of mobile robots at the first location.

M21. The method according to any of the eight preceding embodiments further comprising the mobile robot crossing a traffic road following receiving the assistive action.

M22. The method according to any of the nine preceding embodiments wherein the assistive action comprises observing state of a traffic light and transmitting it to the mobile robot.

The present technology will now be discussed with reference to the accompanying drawings.

### BRIEF DESCRIPTION OF THE DRAWINGS

FIGS. 1a and 1b depicts an embodiment of a service robot;

FIGS. 2a and 2b depict a different embodiment of a service robot;

FIGS. 3a, 3b, 3c and 3d depict schematic partial views of an embodiment of a service robot;

FIG. 4 depicts a schematic embodiment of a system according to one embodiment of the invention;

FIG. 5 schematically depicts a method according to an embodiment of the invention

FIG. 6 shows an embodiment of a mobile robot as per an embodiment of the present invention.

### DESCRIPTION OF EMBODIMENTS

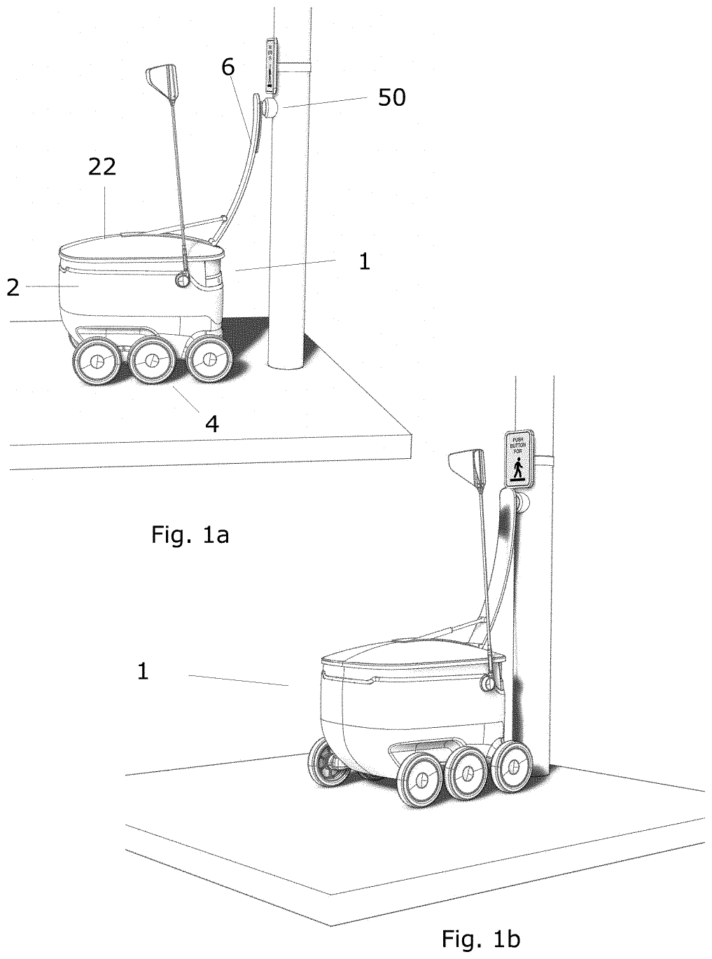

FIGS. 1a and 1b schematically depicts an embodiment of a service robot according to an aspect of the present invention. The service robot 1 is shown engaging an interaction area 50. In the present figures, the interaction area 50 is shown as a pedestrian crossing pushbutton.

The service robot 1 comprises a body 2. The body comprises an upper surface 22 which is shown as convex in the figures. The service robot 1 further comprises a motion component 4, shown as wheels 4. The depicted embodiment shows a service robot 1 with six wheels.

The service robot 1 further comprises an engagement component 6. The engagement component 6 can be configured to engage or activate the interaction area 50. In the depicted embodiments, the engagement component 6 is configured to engage or push the pushbutton 50 or a pedestrian crossing.

The service robot 1 in any of the shown embodiments generally comprises a processing component as well (not shown in the figures). The processing component can serve to control and coordinate the service robot's 1 operations, such as navigating (and generally using the motion component 4), actuating the engagement component 6, or using a communication component (also not shown) to send and receive data, instructions, or operational information.

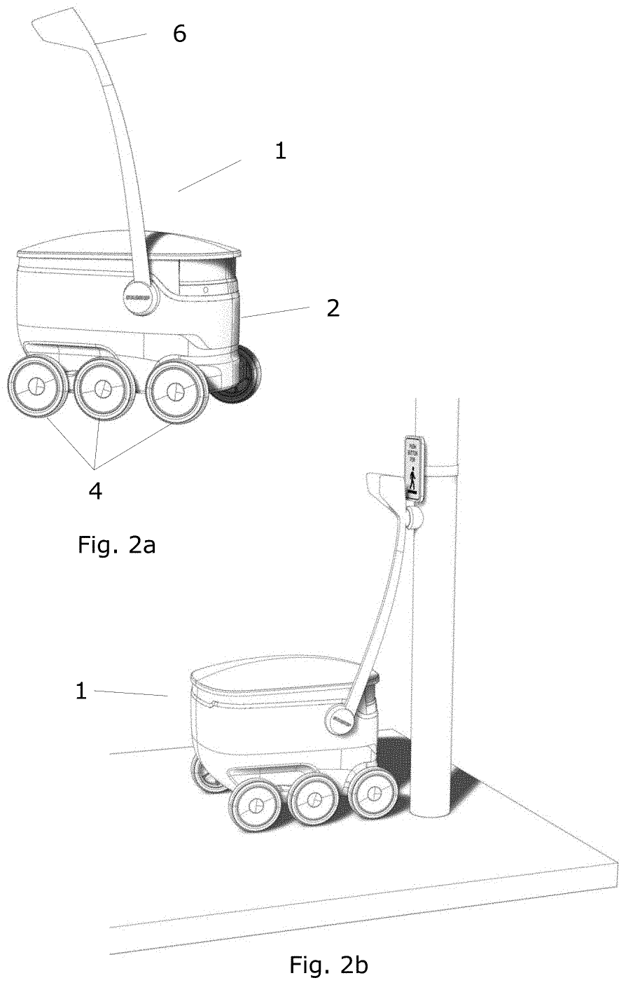

FIGS. 2a and 2b show another embodiment of a service robot. In this embodiment, the engagement component 6 is shown as a flag or antenna that can have a double function of increasing the service robot's visibility and engaging interaction areas. The service robot 1 has a similar body 2 and a motion component 4, also depicted as wheels.

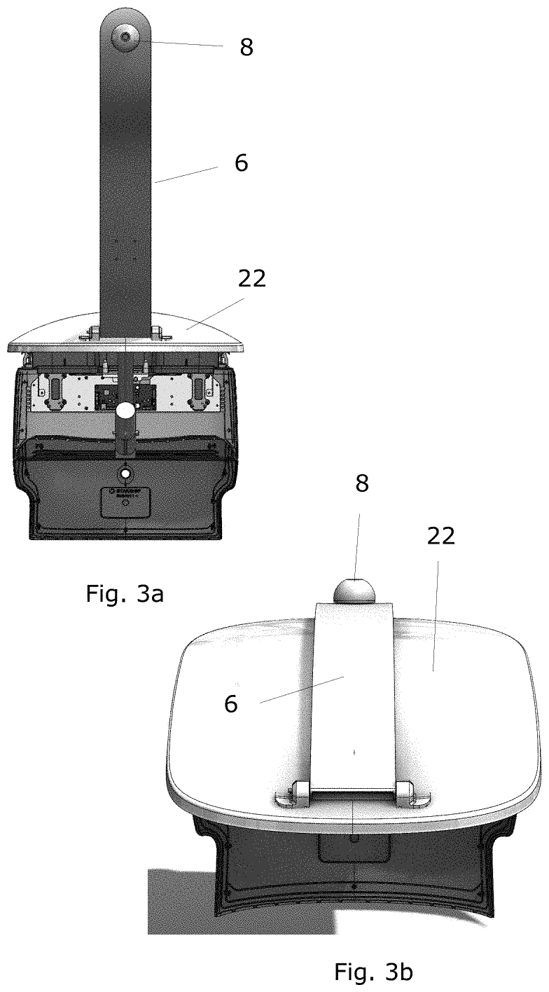

FIGS. 3a, 3b, 3c and 3d show partial views of the service robot 1. Those correspond to the schematic embodiment of FIGS. 1a and 1b. Sensor 8 is shown, placed at the top or end of the engagement component 6. The shown sensor 8 comprises a visual camera 8, but there can be different sensors (such as a Lidar sensor or a Time of Flight sensor), and/or a plurality of sensors. In the shown embodiment, the camera 8 is placed within an indentation of a protruding element that is configured to engage an interaction area.

Upper surface of the body 22 is shown as well. Further, an engagement mechanism 62, protruding through the upper surface 22 is shown. The engagement mechanism 62 comprises a lever connected to a motor that can actuate the engagement component 6, so that it can move between an idle position (as shown in FIG. 3b) and an active position (as shown in FIGS. 3a, 3c and 3d). In the idle position, the engagement component 6 can be advantageously out of the way, so that it does not impede the movement of the service robot 1, not present any inconvenience to passersby if the service robot 1 is travelling. In the active position, the engagement component 6 can engage or activate the interaction area 50.

The engagement mechanism 62 can be implemented differently. For example, the engagement mechanism 62 could comprise a kinematic structure such as folding bars, to optimize space taken by the engagement mechanism 62.

FIG. 3b shows the engagement component 6 protruding slightly from the body's upper surface 22. In other embodiments, the engagement component 6 can be substantially flush with the upper surface 22. That is, the upper surface 22 could comprise an indentation where the engagement component 6 could fit, and from where it could extend beyond the body when moved from an idle into an active position.

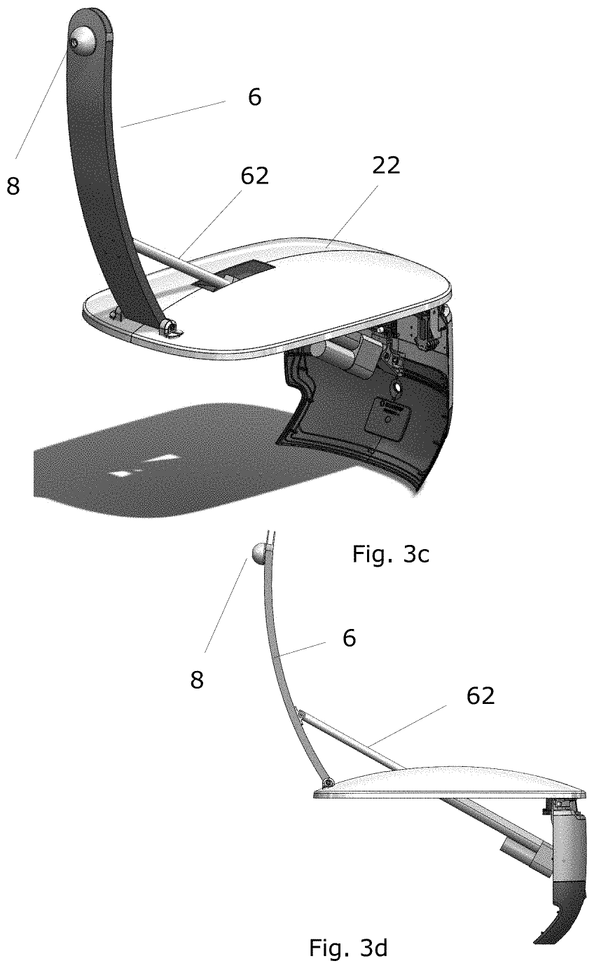

FIG. 4 shows a schematic embodiment of a system according to one aspect of the present invention. A service robot 1 communicates with a server 200, which in turn communicates with a plurality of mobile robots 100. The server 200 is optional, and is shown for illustrative purposes only. In other words, the service robot 1 and the mobile robots 100 can also communicate directly. In the depicted embodiment, the server 200 may coordinate the operations of the mobile robots and the service robot 1. That is, the server 200 may direct the service robot 1 to navigate to different locations in order to assist different mobile robots 100. Additionally or alternatively, the service robot 1 may coordinate at least part of operations of mobile robots 100. For example, the service robot 1 may coordinate a plurality of mobile robots 100 crossing a traffic road via a pedestrian crossing. On busy routes, a queue of mobile robots may form, all waiting to cross the traffic road to navigate to their destination. This may be undesired, as the robots may block parts of the sidewalk, arrive at their destination later than expected, and/or generally the operations of the mobile robots may be slowed down. The service robot 1 may then be placed in the vicinity of such busy road crossings in order to streamline mobile robot operations. The service robot 1 and the mobile robots 100 may also be coordinated by the server 200, which might calculate optimal routes for the robots and optimal placement for the service robot 1. The service robot 1 may observe the road crossing and transmit data useful to the mobile robots 100 in order to cross it as fast as possible (e.g. any vehicles detected within the robots' 100 blind spots or outside their field of view, state of the traffic light, etc). The service robot 1 may also coordinate (or enable the server 200 to coordinate) a plurality of robots crossing the pedestrian crossing in tandem or in formation (e.g. a column, pairwise crossing, or the like). This can also allow for quicker road crossing, since the mobile robots 100 would not need to individually ensure that the crossing is safe to perform, but would rather be authorized by the service robot 1 to cross without first stopping and verifying the safety of such crossing. The service robot 1 can use a plurality of sensors to ensure that the crossing is safe (e.g. a combination of cameras and a time of flight sensor or a radar). Additionally, the service robot 1 can be placed at a better vantage point to observe the intersection compared to the mobile robots 100, which would observe it from the pedestrian crossing.

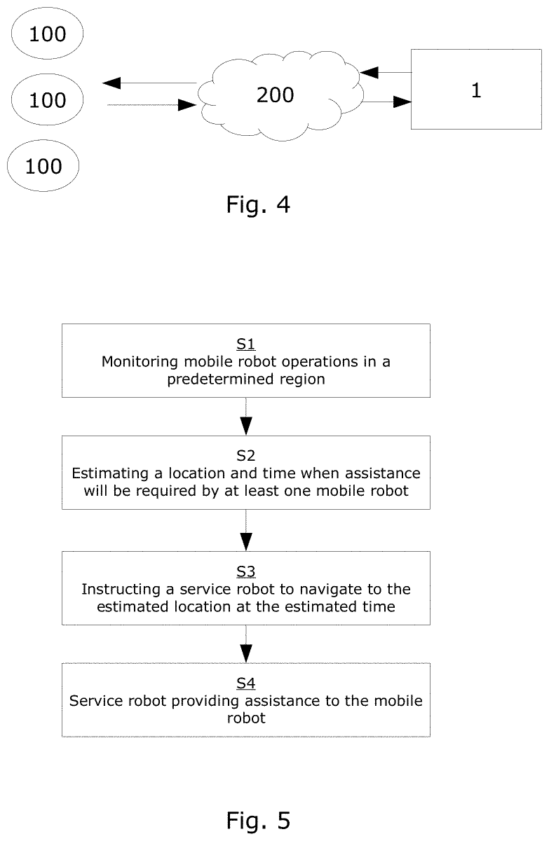

FIG. 5 schematically shows an embodiment of a method for assisting mobile robot operations. In S1, the mobile robot operations in a predetermined region are monitored. The region can comprise a neighborhood, a campus, a shopping center or the like. In S2, a location and time for providing assistance to the mobile robot by the service robot are estimated. In S3, the service robot is instructed to navigate to the estimated location so as to arrive at the estimated time. In S4, the service robot provides assistance to the mobile robot. The service robot can then depart the location in order to assist a different mobile robot in a different location for example.

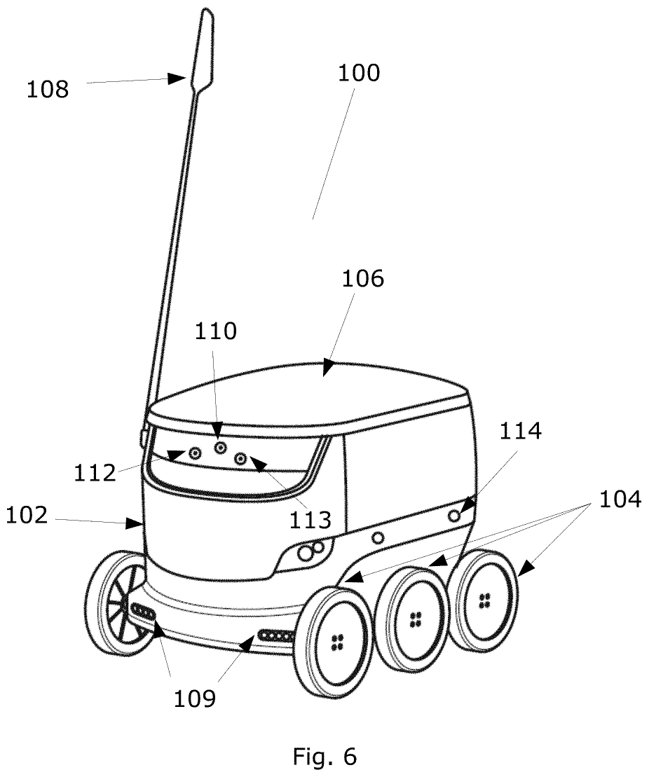

FIG. 6 demonstrates an exemplary embodiment of the mobile robot 100. The mobile robot 100 can comprise a delivery or a vending robot, that is, it can transport and deliver packages, consumable items, groceries or other items to customers. Preferably, the mobile robot 100 is outfitted with a beverage module (not shown in the figure).

The mobile robot 100 comprises a robot body 102. The body 102 comprises an item compartment in which items can be placed and transported by the robot (not shown in the present figure).

The mobile robot 100 further comprises a robot motion component 104 (depicted as wheels 104). In the present embodiment, the robot motion component 104 comprises six wheels 104. This can be particularly advantageous for the mobile robot 100 when traversing curbstones or other similar obstacles on the way to delivery recipients.

The mobile robot 100 comprises a lid 106. The lid 106 can be placed over the item compartment and locked to prevent unauthorized access to the beverage module.

The mobile robot 100 further comprises a robot signaling device 108, depicted here as a flagpole or stick 108 used to increase the visibility of the robot 100. Particularly, the visibility of the robot 100 during road crossings can be increased. In some embodiments, the signaling device 108 can comprise an antenna. The mobile robot 100 further comprises robot headlights 109 configured to facilitate the robot's navigation in reduced natural light scenarios and/or increase the robot's visibility further. The headlights are schematically depicted as two symmetric lights 109, but can comprise one light, a plurality of lights arranged differently and other similar arrangements.

The mobile robot 100 also comprises robot sensors 110, 112, 113, 114. The sensors are depicted as visual cameras (110, 112, 113) and ultrasonic sensors (114) in the figure, but can also comprise radar sensors, lidar sensors, time of flight cameras and/or other sensors. Further sensors can also be present on the mobile robot 100. One sensor can comprise a front camera 110. The front camera 110 can be generally forward facing. The sensors may also comprise front (112, 113), side and/or back stereo cameras. The front stereo cameras 112 and 113 can be slightly downward facing. The side stereo cameras (not depicted) can be forward-sideways facing. The back camera (not depicted) may be a mono or a stereo camera can be generally backward facing. The sensors present on multiple sides of the robot can contribute to its situational awareness and navigation capabilities. That is, the robot 100 can be configured to detect approaching objects and/or hazardous moving objects from a plurality of sides and act accordingly.

The robot sensors can also allow the robot 100 to navigate and travel to its destinations at least partially autonomously. That is, the robot can be configured to map its surroundings, localize itself on such a map and navigate towards different destinations using in part the input received from the multiple sensors.

The service robot 1 can be structurally and physically similar to the mobile robot 100. However, the service robot 1 can be specifically optimized for performing an assistive action, such as pushing a button, whereas the mobile robot 100 can be optimized for tasks such as item delivery and transportation or the like. The service robot 1 may not have an item compartment, or the item compartment may be utilized for the engagement component mechanism or the like.

### LIST OF REFERENCE NUMERALS

1—Service robot
2—Body
22—Upper surface of the body
4—Motion component
6—Engagement component
62—Engagement mechanism
8—Sensor
10—Communication component
50—Interaction area
100—Mobile robot
102—Robot body
104—Robot motion component
106—Lid
108—Robot signaling device
109—Headlights
110—Front camera
112—Front stereo camera
113—Front stereo camera
114—Ultrasonic sensor
116—Robot communication component
200—Server

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be the preferred order, but it may not be mandatory to carry out the steps in the recited order. That is, unless otherwise specified or unless clear to the skilled person, the order in which steps are recited may not be mandatory. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

1. A service robot configured to assist mobile robots, the service robot comprising:
a body;
a motion component fitted to the body and configured to propel the service robot in a direction;
an engagement component configured to exert a localized force on a geometrically defined interaction area;
a sensor configured to detect the interaction area; and
a communication component configured to at least communicate with mobile robots and to at least receive requests to engage the interaction area.

2. The service robot according to claim 1, wherein the interaction area comprises a pushbutton.

3. The service robot according to claim 1, wherein the engagement component is motor operated and comprises a mechanical arm.

4. The service robot according to claim 1, wherein the engagement component is configured to exert a force of at least 10 N on the interaction area.

5. The service robot according to claim 1, wherein the engagement component comprises at least two positions comprising an idle position and an active position and wherein
in the idle position the engagement component is substantially flush with an upper surface of the body; and
in the active position the engagement component is substantially protruding from the body.

6. The service robot according to claim 5, wherein the engagement component is configured to actuate from the idle position to the active position in response to a request to engage the interaction area.

7. The service robot according to claim 1, wherein the motion component is configured to displace the body substantially vertically in response to the sensor detecting the interaction area.

8. The service robot according to claim 1, wherein the engagement component is configured to exert a localized force on an area at a height of between 80 and 150 cm above ground.

9. A system for assisting mobile robots, the system comprising:
at least one mobile robot configured to navigate in unstructured outdoor environments on pedestrian walkways; and
at least one service robot according to claim 1,
wherein the service robot is configured to assist the mobile robot by engaging the interaction area.

10. The system according to claim 9, wherein the service robot is configured to assist the mobile robot at a first location and time upon request.

11. The system according to claim 9, wherein the service robot is configured to assist the mobile robot by pressing a pedestrian crossing pushbutton so as to enable the mobile robot to cross a traffic road.

12. The system according to claim 9,
wherein the service robot is configured to assist the mobile robot at a first location, and
wherein the system further comprises a server configured to communicate with the mobile robot and the service robot and wherein the server is configured to instruct the service robot to navigate to the first location where the service robot can assist the mobile robot.

13. The system according to claim 12, wherein the system comprises a plurality of mobile robots and wherein the server is configured to optimize placement of the service robot based on ongoing mobile robot operations.

14. The system according to claim 12, wherein the server is configured to estimate navigational time of the service robot and the mobile robot and instruct the service robot to start navigating to the first location.

15. A method for assisting mobile robots, the method comprising:
a mobile robot approaching a pedestrian road crossing at a first location;
the mobile robot requesting assistance from a service robot;
the service robot executing at least one assistive action; and
in response to the assistive action, the mobile robot crossing the road via the pedestrian road crossing.

16. The method according to claim 15, further comprising the service robot travelling to the first location ahead of the mobile robot so as to provide assistive action upon arrival of the mobile robot.

17. The method according to claim 15, further comprising the service robot departing the first location after executing the assistive action.

18. The method according to claim 17, further comprising the service robot travelling to a second location and providing an assistive action to a second mobile robot at the second location.
